(19) United States
(12) Patent Application Publication
(10) Pub. No.: US 2025/0180895 A1
(43) Pub. Date: Jun. 5, 2025

(54) HEATER, LENS UNIT, CAMERA MODULE, IN-VEHICLE SYSTEM, MOBILE BODY, AND HEATER INCORPORATION METHOD

(71) Applicant: Maxell, Ltd., Kyoto (JP)

(72) Inventors: Shigehito MITOMA, Kyoto (JP); Takayuki SUGINOME, Kyoto (JP); Yosuke SUZUKI, Kyoto (JP); Koshi FUJII, Kyoto (JP)

(73) Assignee: Maxell, Ltd., Kyoto (JP)

(21) Appl. No.: 18/681,070

(22) PCT Filed: Apr. 15, 2022
(86) PCT No.: PCT/JP2022/017913

§ 371 Date: Feb. 21, 2025

(30) Foreign Application Priority Data
Aug. 6, 2021 (JP) 2021-129847

(51) Int. Cl. G02B 27/00; B60R 1/20; B60S 1/02; B60S 1/56; G06V 10/147; G06V 20/56

(52) U.S. Cl. CPC G02B 27/0006; B60R 1/20; B60S 1/56; G06V 10/147; G06V 20/56; B60R 2300/307; B60S 1/026

(57) ABSTRACT

Provided are a heater, a lens unit, a camera module, an in-vehicle system, a mobile body, and a heater incorporation method capable of securing easy incorporation and high electrical reliability without increasing number of components and lowering incorporation accuracy.

A heater 30 of the present invention includes a heating unit 32 as an annular body that is disposed between lenses and generates heat by power supply, a connector 34 that is electrically connected to a power supply side, and a power supply unit 36 that extends so as to electrically connect the connector 34 and the heating unit 32 and supplies power to the heating unit 32, in which the heating unit 32, the power supply unit 36, and the connector 34 are integrally formed, and a part of the annular body of the heating unit 32 is divided.

### TECHNICAL FIELD

The present invention particularly relates to a heater, a lens unit, a camera module, an in-vehicle system, a mobile body on which the in-vehicle system is mounted, and a heater incorporation method that is capable of constituting an in-vehicle camera mounted on a vehicle such as an automobile.

### BACKGROUND ART

In recent years, in-vehicle cameras have been mounted on automobiles to support parking and prevent collision by image recognition, and further attempts have been made to apply this to automatic driving. Furthermore, a camera module of such an in-vehicle camera generally includes a lens unit including a lens group that is formed by arranging a plurality of lenses along an optical axis, a lens barrel that accommodates and holds the lens group, and a diaphragm member that is disposed between lenses at least at one position of the lens group (see, for example, Patent Literature 1).

The lens unit (the camera module) having the above configuration can be used not only in an in-vehicle camera but also in various optical apparatuses. In particular, in a case where the lens unit is exposed to an external environment in a cold region, freezing of the lens surface or snow deposition on the lens can be assumed. Therefore, the lens unit generally has a snow melting function, an anti-fog function, and the like. Specifically, for example, as schematically illustrated in FIG. 16(a), in such a lens unit, a heater 130 is interposed between a surface 101a facing an image side of the first lens 101 and a surface 102a facing an object side of a second lens 102 adjacent to the first lens 101 on the image side in order to warm the first lens 101 that is located closest to the object side and exposed from a lens barrel 120 (exposed to an external environment) among a lens group L (in FIG. 16(a), only two lenses of lens group L on the object side are illustrated for simplification) accommodated and held in the lens barrel 120.

The heater 130 incorporated in the lens barrel 120 in this manner is widely used as the most effective heating means capable of efficiently transmitting the generated heat to the surface of the first lens 101.

### CITATION LIST

### Patent Literature

Patent Literature 1: JP 2013-231993 A

### SUMMARY OF INVENTION

### Technical Problem

Meanwhile, power is supplied to the heater 130 via electrical wiring, generally via a flexible printed circuit board (FPC). Therefore, for example, as illustrated in FIG. 16(b), a heater 130 includes a heating unit 130a which is an annular heater main body interposed between the lenses 101 and 102, and a power supply unit 130b including an FPC extending laterally from the heating unit 130a, and the heating unit 130a generates heat by power supply through the power supply unit 130b and the heat is transmitted to the lens 101. Then, in general, the power supply unit 130b is configured such that after the heating unit 130a is disposed between the lenses 101 and 102, the power is led out to the outside of the lens barrel through a lead-out hole 120a provided in a side surface of the lens barrel 120, and the power supply unit is electrically connected to a power supply side.

The power supply unit 130b of such a heater 130 is electrically connected to the power supply side via a connector, but from a viewpoint of reliability of electrical components and the like, specifically, from a viewpoint of preventing electrical connection failure, it is desirable to integrate the heater 130 with the connector. In other words, as illustrated in FIG. 17, it is desirable to construct an integrated heater 130A in which a heating unit 130a, a power supply unit 130b, and a connector 130c are integrally formed. As a result, not only electrical reliability is improved, but also the number of components is reduced, which can contribute to reduction in manufacturing cost.

However, particularly in a case where such an integrated heater 130A is installed in a lens unit mounted on a vehicle such as an automobile and receives power supply from a vehicle side, a size of the connector 130c tends to increase (sometimes becomes larger than the size of the lens unit). Therefore, it is difficult to lead the connector 130c to the outside together with the power supply unit 130b through the lead-out hole 120a provided on the side surface of the lens barrel 120, and how to incorporate the integrated heater 130A into the lens unit becomes a problem.

Regarding this, for example, a heater incorporation method is considered in which the lens barrel 120 is divided into two near the position where the integrated heater 130A is to be installed, the heating unit 130a is installed between the lenses 102 and 102 in the divided state, the power supply unit 130b and the connector 130c are led out to the outside of the lens barrel 120, and then the two divided lens barrel portions are connected to each other. In this case, not only the number of components of the lens unit increases, but also positional displacement of the optical system and the heater may occur due to incorporation accuracy and the like, and there may be a problem that desired optical performance cannot be obtained or the snow melting function and anti-fog function cannot be sufficiently obtained.

The present invention has been made in view of the above circumstances, and an object of the present invention is to provide a heater, a lens unit, a camera module, an in-vehicle system, a mobile body, and a heater incorporation method capable of ensuring easy incorporation and high electrical reliability without increasing the number of components and lowering the incorporation accuracy.

### Solution to Problem

In order to solve the above problems, the present invention is a heater that is installed in a lens unit formed by housing a plurality of lenses in a lens barrel and transfers heat generated by power supply to the lenses, the heater including: a heating unit as an annular body that is disposed between the lenses and generates heat by power supply; a connector electrically connected to the power supply side; and a power supply unit that extends to electrically connect the connector and the heating unit and supplies power to the heating unit, in which the heating unit, the power supply unit, and the connector are integrally formed, and a part of the annular body of the heating unit is divided.

In this way, according to the above configuration of the present invention, since the heating unit, the power supply unit, and the connector are integrally formed (the integrated heater), it is possible to prevent electrical connection failure and the like, and not only increase the electrical reliability but also reduce the number of components, which can contribute to reduction of manufacturing cost. Furthermore, since a part of the annular body of the heating unit is divided, for example, the heating unit can be easily introduced from the outside to the inside of the lens barrel by introducing the heating unit into the lens barrel along an annular shape using a division portion from the through hole provided on the side surface of the lens barrel. This is advantageous in that the integration of the integrated heater into the lens unit can be facilitated even in a situation where it is difficult to lead out the connector together with the power supply unit to the outside of the lens barrel through the through hole of the lens barrel as in the conventional art, particularly in a case where the connector is large in size (in particular, the size of the connector exceeds the size of the lens unit) when the integrated heater is installed in the lens unit mounted on a vehicle such as an automobile and receives power supply from the vehicle side. Furthermore, in this way, according to the above configuration of the present invention, since the integrated heater can be incorporated from the outside into the lens barrel as long as the through hole is formed in the lens barrel, it is not necessary to divide the lens barrel into two and incorporate the heater. Therefore, there is no need to increase the number of components of the lens unit, and it is possible to avoid a situation (deterioration in incorporation accuracy) in which a positional deviation or the like of the optical system or the heater occurs during connecting the two divided lens barrel portions. As a result, it is possible to obtain a sufficient snow melting and anti-fog function by the heater while securing desired optical performance.

Note that in the above configuration, “divided” refers to a separated state in which a part of the annular body is not connected, and refers to a portion that communicates the inside and the outside of the closed annular body, for example, a simple slit (a cut), a notch extending over a predetermined length along the annular shape (an opening at a predetermined width), or the like. Furthermore, in the present invention, “integrally formed” means being formed in a non-detachable connected state that cannot be separated unless mechanically broken.

Furthermore, in the above configuration, the shape of the annular body of the heating unit is not particularly limited, and the heating unit may have any shape such as a circular shape or a rectangular shape as long as the heating unit can efficiently and effectively heat the first lens. Furthermore, examples of the heating unit include a positive temperature coefficient (PTC) heater.

Furthermore, in the above configuration, the power supply unit may be formed of a metal plate or an electric wire, for example, a lead wire, or may be formed of a wire made of flexible printed circuits (FPCs). In this case, electric resistance of the power supply unit needs to be lower than that of the heating unit so as not to generate heat in the power supply unit. Furthermore, in a case where the power supply unit and the heating unit are electrically connected to each other, a conductive adhesive may be used, and anisotropic conductive adhesive (ACP) may be used as the conductive adhesive, for example. ACP has a feature that only a pressed portion is conducted in a case where the electrode + and − is near, and thus has an advantage that manufacturing process can be simplified. Furthermore, the connector is electrically connected to the power supply side, and examples of the power supply side to which the connector is connected include a lithium storage battery, a lead storage battery, and an all-solid-state battery.

Furthermore, in order to solve the problem described above, the present invention is a heater that is installed in a lens unit formed by housing a plurality of lenses in a lens barrel and transmits heat generated by power supply to the lenses, the heater including a pair of first and second heater units formed integrally with a connector electrically connected to a power supply side, in which the first heater unit includes a first heating unit that is disposed between the lenses and generates heat by power supply, and a first power supply unit that extends so as to electrically connect the connector and the first heating unit and supplies power to the first heating unit, and the second heater unit includes a second heating unit that is disposed between the lenses and generates heat by power supply, and, a second power supply unit that extends so as to electrically connect the connector and the second heating unit and supplies power to the second heating unit, in which the first and second heating units face each other to form one annular body.

In this way, according to the above configuration of the present invention, since the heating unit, the power supply unit, and the connector are integrally formed (the integrated heater), as described above, the electrical reliability is high, and the number of components can be suppressed to contribute to reduction in manufacturing cost. Furthermore, since the integrated heater is separated into the pair of first and second heater units, and the heating units of the respective heater units face each other to form one annular body, it is possible to easily introduce the heating units from the outside to the inside of the lens barrel in a stepwise manner, for example, by individually introducing the heating units of the respective heater units forming a simple part of the annular body (non-annular portion smaller than the annular body) into the lens barrel from the through holes provided on the side surface of the lens barrel. Therefore, as described above, even in a case where the size of the connector is large, it is easy to incorporate the integrated heater into the lens unit. Furthermore, according to the above configuration of the present invention, since the first heating unit and the second heating unit cooperate to form a completely closed annular body that is not divided, a sufficient amount of heat generation can be secured, and heating distribution (temperature distribution) can be made uniform over the entire lens. Note that in the above configuration, the pair of first and second heater units may be individually and integrally formed with the corresponding connectors, or may be integrally formed with a common connector.

Furthermore, in order to solve the problems described above, the present invention is a heater that is installed in a lens unit formed by accommodating a plurality of lenses in a lens barrel and transmits heat generated by power supply to the lenses, the heater including: a heating unit as an annular body that is disposed between the lenses and generates heat by power supply; a connector electrically connected to a power supply side; and a power supply unit that extends along a center line of the annular body so as to electrically connect the connector and the heating unit and supplies power to the heating unit, in which the heating unit, the power supply unit, and the connector are integrally formed, and the heating unit and the power supply unit can be bent along the center line of the annular body.

In this way, according to the above configuration of the present invention, since the heating unit, the power supply unit, and the connector are integrally formed (the integrated heater), as described above, the electrical reliability is high, and the number of components can be suppressed to contribute to reduction in manufacturing cost. Furthermore, since the heating unit and the power supply unit can be bent along the center line of the annular body, in a state where the heating unit and the power supply unit are bent along the center line of the annular body, the heating unit can be easily introduced from the outside to the inside of the lens barrel by, for example, introducing the heating unit into the lens barrel through the through hole provided on the side surface of the lens barrel. Therefore, as described above, even in a case where the size of the connector is large, it is easy to incorporate the integrated heater into the lens unit. Furthermore, according to the above configuration of the present invention, since the annular body in which the heating unit is completely closed without being divided is formed, a sufficient amount of heat generation can be secured, and the heating distribution (the temperature distribution) can be made uniform over the entire lens.

Furthermore, in such a bendable integrated heater, the heating unit may include a heating element and at least a pair of electrodes electrically connected to the heating element, and a current may flow through the heating element by applying a voltage between the electrodes to generate Joule heat on a surface of the heating element. In this case, the heating unit and the power supply unit are preferably bendable by separating the electrode and the heating element along the center line of the annular body. According to this, it is possible to effectively realize easy bending of the heater without impairing the power supply and heat generation function.

Furthermore, the present invention also provides a lens unit having the heater described above, a camera module having the lens unit, an in-vehicle system having the camera module, a mobile body on which the in-vehicle system is mounted, and a heater incorporation method. By such a lens unit, a camera module, an in-vehicle system, a mobile body, and a heater incorporation method, it is possible to obtain the same operation and effect as those of the heaters described above. Note that the “mobile body” refers to all objects that can move, and examples thereof include vehicles and the like.

### Advantageous Effects of Invention

According to the present invention, since a part of the annular body of the heating unit of the integrated heater is divided, or the integrated heater is separated into the pair of first and second heater units, and the heating units of the respective heater units face each other to form one annular body, or the heating unit and the power supply unit of the integrated heater can be bent along the center line of the annular body of the heating unit, easy incorporation and high electrical reliability of the heater can be secured without increasing the number of components and lowering the incorporation accuracy.

### BRIEF DESCRIPTION OF DRAWINGS

FIG. 1 is a schematic longitudinal sectional view along an optical axis direction of a lens unit according to an embodiment of the present invention.

FIG. 2 is a schematic plan view of the integrated heater according to the first embodiment incorporated in the lens unit of FIG. 1.

FIG. 3 is a sectional view taken along a line A-A′ of FIG. 2.

FIG. 4 is a schematic longitudinal sectional view along the optical axis direction of the lens unit illustrating a first step of the incorporation method of incorporating the heater of FIG. 3 into the lens unit of FIG. 1.

FIG. 5 is a schematic longitudinal sectional view along the optical axis direction of the lens unit illustrating a second step of the incorporation method of incorporating the heater of FIG. 3 into the lens unit of FIG. 1.

FIG. 6 is a schematic longitudinal sectional view along the optical axis direction of the lens unit illustrating a third step of the incorporation method of incorporating the heater of FIG. 3 into the lens unit of FIG. 1.

FIG. 7 is a schematic sectional view illustrating a state in which the heating unit of the heater in FIG. 2 is introduced into the lens barrel through a through hole provided in a side surface of the lens barrel of the lens unit in FIG. 1.

FIG. 8 is a schematic longitudinal sectional view along an optical axis direction of a camera module including the lens unit of FIG. 1.

FIG. 9 is a schematic plan view of an integrated heater according to a second embodiment that can be incorporated in the lens unit of FIG. 1.

FIG. 10 is a schematic sectional view illustrating a state in which the heating unit of the heater in FIG. 9 is introduced into the lens barrel through the through hole provided in the side surface of the lens barrel of the lens unit in FIG. 1.

FIG. 11 is a schematic plan view of an integrated heater according to a third embodiment that can be incorporated in the lens unit of FIG. 1.

FIG. 12 is a sectional view taken along a line B-B′ in FIG. 11.

FIG. 13 is a schematic sectional view illustrating a state in which the heating unit of the heater in FIG. 11 is introduced into the lens barrel through the through hole provided in the side surface of the lens barrel of the lens unit in FIG. 1.

FIG. 14 is a schematic view of a vehicle as a mobile body on which an imaging system (an in-vehicle system) including a camera module according to an embodiment of the present invention is mounted.

FIG. 15 is a block diagram illustrating a configuration of an imaging apparatus constituting the imaging system in FIG. 14.

FIG. 16(a) is a partial schematic sectional view of a lens unit with a conventional heater, and FIG. 16(b) is a plan view illustrating an example of the conventional heater.

FIG. 17 is a schematic plan view of a conventional integrated heater.

### DESCRIPTION OF EMBODIMENTS

Hereinafter, an embodiment of the present invention will be described with reference to the drawings. The present embodiment can realize a highly reliable system particularly in a sensing system and contributes to development of a tough infrastructure, and targets “9.1 To support economic development and human well-being with a focus on cheap and equitable access to all people, develop quality, reliable, sustainable and resilient infrastructures, including region and cross-boundary infrastructures.” of “9. To establish the basis of industry and technological innovation.” of the sustainable development goals (SDGs) proposed by the United Nations.

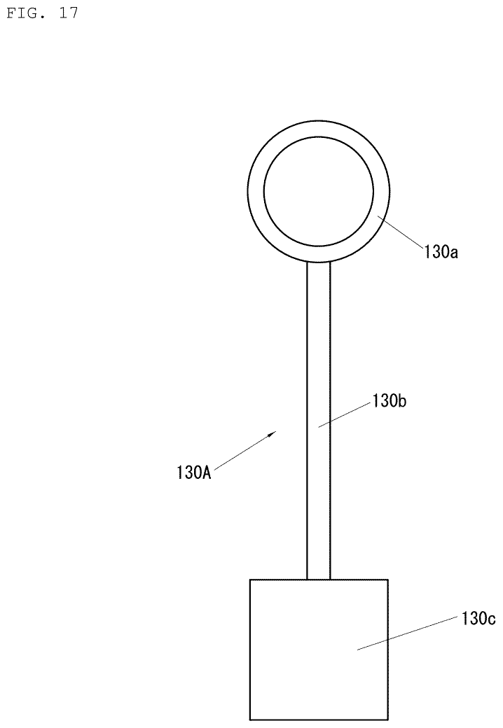

Note that the lens unit in which the heater of the present embodiment described below is incorporated is particularly for a camera module such as an in-vehicle camera, and for example, is fixedly installed on an outer surface side of an automobile, and wiring is drawn into the automobile and connected to a display or other apparatuses. Furthermore, in all the drawings including FIG. 16 described above, hatching is omitted for the lens.

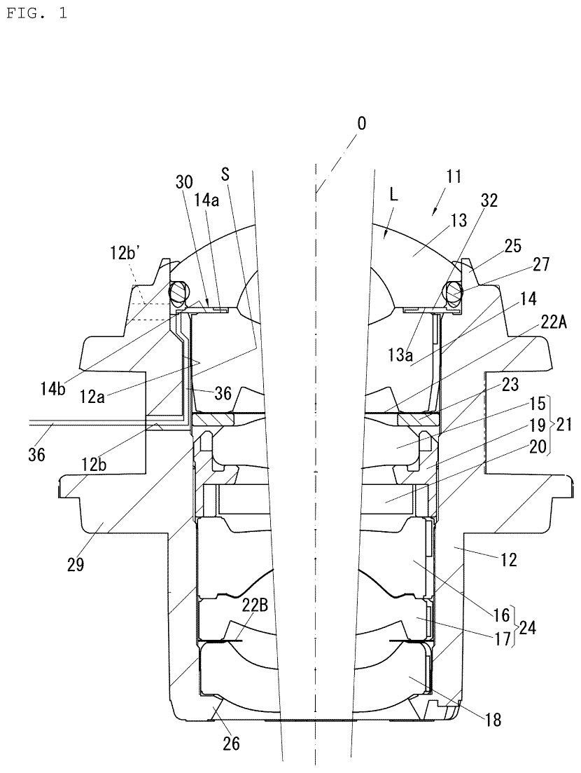

FIG. 1 illustrates a lens unit 11 according to a first embodiment of the present invention. As illustrated in FIG. 1, the lens unit 11 includes a cylindrical lens barrel 12 and a plurality of lenses arranged in an inner accommodation space S of the lens barrel 12, for example, six lenses including a first lens 13, a second lens 14, a third lens 15, a fourth lens 16, a fifth lens 17, and a sixth lens 18. In this case, the third lens 15 is supported by an intermediate ring 19 together with an infrared cut filter (IRCF) 20, thereby constituting a subassembly 21 in which the lens and the filter are integrated as a unit. Furthermore, the fourth lens 16 and the fifth lens 17 constitute a bonded lens 24 formed by being bonded to each other, and a diaphragm member 22A and an intermediate ring 23 are interposed between the second lens 14 and the third lens 15 in a state of being overlapped with each other. Furthermore, a diaphragm member 22B is also interposed between the fifth lens 17 and the sixth lens 18. The diaphragm members 22A and 22B are “aperture diaphragms” that limit the amount of transmitted light and determine an F value serving as an index of brightness, or “light-shielding diaphragms” that shield light beams that cause ghosts and light beams that cause aberrations. An in-vehicle camera including such a lens unit 11 includes a lens unit 11, a substrate having an image sensor (not illustrated), and an installation member (not illustrated) that installs the substrate in a vehicle such as an automobile.

Note that in the present embodiment, the first lens 13 that can be exposed to the outside is a glass lens, and the other second to sixth lenses 14, 15, 16, 17, and 18 on the inner side are all resin lenses formed of resin (plastic), but the present invention is not limited thereto. Furthermore, the lens barrel 12 accommodating these lenses 13, 14, 15, 16, 17, and 18 is made of resin in the present embodiment, but may be made of metal. Furthermore, the shapes of the lens barrel and the lens, the number of lenses, and the like can be arbitrarily set according to the application and the like.

The plurality of lenses 13, 14, 15, 16, 17, and 18 fixed to and supported by the lens barrel 12 are arranged with their optical axes aligned with each other, and the lenses 13, 14, 15, 16, and 17 are arranged along one optical axis O to constitute a group of lens groups L used for imaging. Furthermore, an antireflection film, a hydrophilic film, a water-repellent film, and the like are provided on the surfaces of these lenses 13, 14, 15, 16, 17, and 18 as necessary.

At an end portion on the object side of the lens barrel 12 (an upper end portion in FIG. 1), a caulking portion 25 obtained by thermally caulking the end portion radially inward is provided, and the first lens 13 located closest to the object side of the lens group L is fixed to the end portion on the object side of the lens barrel 12 by the caulking portion 25.

Furthermore, an inner flange portion 26 having an opening portion with a diameter smaller than that of the sixth lens 18 is provided at an end portion (a lower end portion in FIG. 1) on an image side of the lens barrel 12. The plurality of lenses 13, 14, and 15 (the subassembly 21), 16, 17, and 18 constituting the lens group L, the intermediate rings 19 and 23, and the diaphragm members 22A and 22B are held in the lens barrel 12 by the inner flange portion 26 and the caulking portion 25.

A reduced diameter portion having a reduced diameter in an image side portion of the lens 13 is provided on an outer peripheral surface of the first lens 13 located closest to the object side, an O-ring 27 as a seal member is provided in the reduced diameter portion, and a space between the outer peripheral surface of the lens 13 and the inner peripheral surface of the lens barrel 12 is sealed at an object side end portion of the lens barrel 12. As a result, this prevents fine particles such as water and dust from entering the lens barrel 12 from the object side end portion of the lens unit 11. Note that the seal member interposed between the first lens 13 and the lens barrel 12 is not limited to the O-ring, and may have any form as long as it is an annular body capable of sealing between the first lens 13 and the lens barrel 12. Note that on the outer peripheral surface of the lens barrel 12, an outer flange portion 29 used when the lens barrel 12 is installed in the in-vehicle camera is provided in a flange shape on the outer peripheral surface of the lens barrel 12.

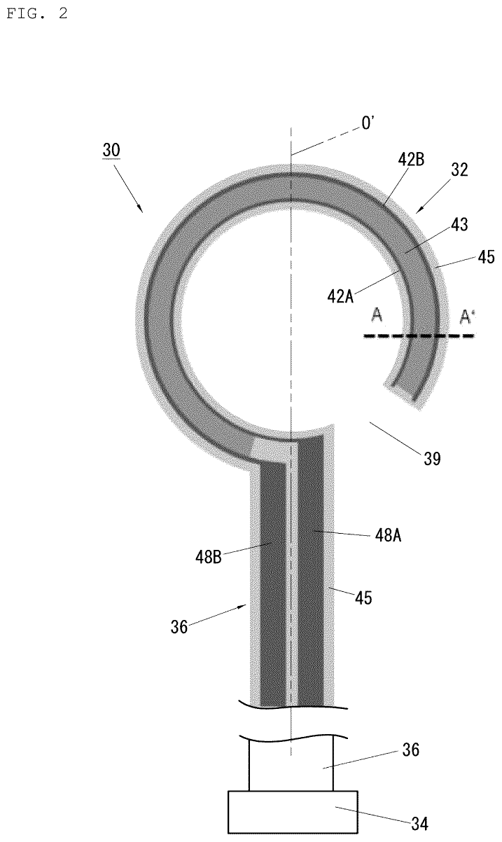

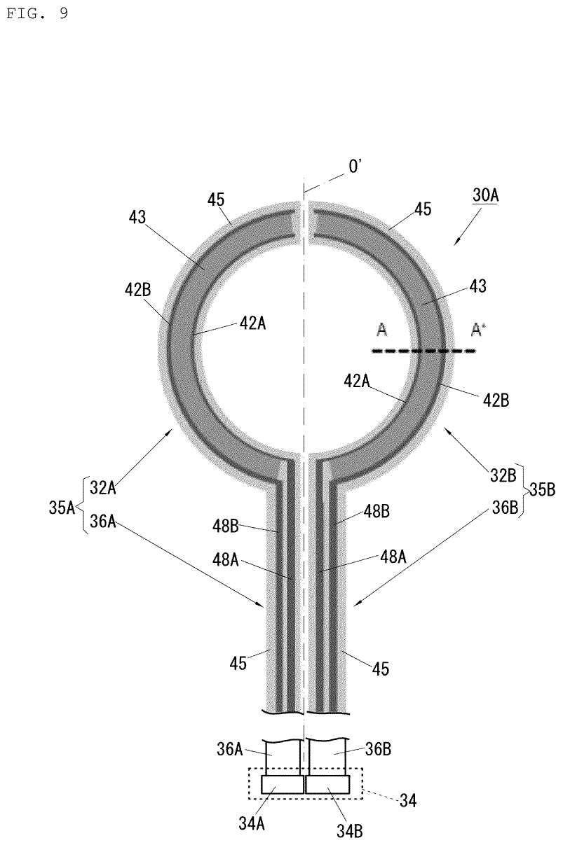

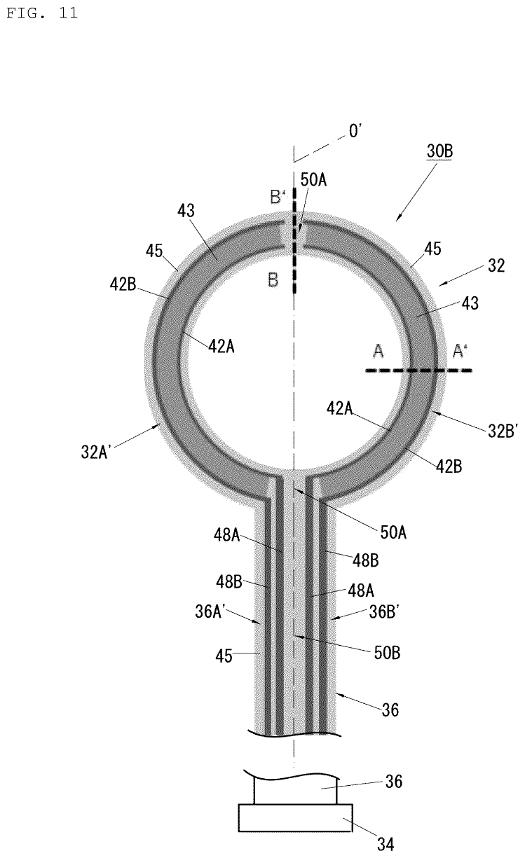

Furthermore, in the present embodiment, the heater 30 for transmitting heat generated by the power supply to the first lens 13 located closest to the object side of lens group L is disposed in the lens barrel 12. As clearly shown in FIG. 2, the heater 30 includes a heating unit 32 as, for example, a positive temperature coefficient (PTC) heater unit that generates heat by the power supply, a connector 34 electrically connected to the power supply side (not illustrated), and a power supply unit 36 that extends so as to electrically connect the connector 34 and the heating unit 32 to supply power to the heating unit 32, and is formed by integrally forming the heating unit 32, the power supply unit 36, and the connector 34. Note that in the present embodiment, since the connector 34 is installed in the lens unit 11 mounted on a vehicle such as an automobile and receives power supply from a vehicle side, the connector 34 has a considerably larger size than the heating unit 32 (for example, the size of the connector 34 exceeds the size of the lens unit 11). However, in FIG. 2 (the same applies to FIG. 9 and FIG. 11 to be described later), the connector 34 is drawn in a size substantially equal to those of the heating unit 32 and the power supply unit 36 for convenience in a relationship of mainly depicting the heating unit and the power supply unit.

In order to warm the first lens 13 whose object-side surface is exposed from the lens barrel 12 and exposed to an external environment, the heating unit 32 is formed as a partially divided circular annular body substantially corresponding to a shape of the image-side surface 13a of the first lens 13, and is interposed between the surface 13a facing the image side of the first lens 13 and a surface 14a facing the object side of the second lens 14 adjacent to the first lens 13 on the image side. In particular, in the present embodiment, the heating unit 32 is positioned outside a range of an effective diameter of the lens 14 in an annular groove 14b formed on the outer periphery of surface 14a of the second lens 14 facing the object side.

Furthermore, the heating unit 32 includes a division portion 39 that divides a part of the annular body. In the present embodiment, the division portion 39 is formed so as to open the annular body over a predetermined angle range from a connection portion between the heating unit 32 and the power supply unit 36, and communicates the inside and the outside of the annular body. However, the division portion 39 is not limited to such a forming form, and may be provided at another position along the annular body, and an opening width thereof can also be arbitrarily set (it may be a simple slit).

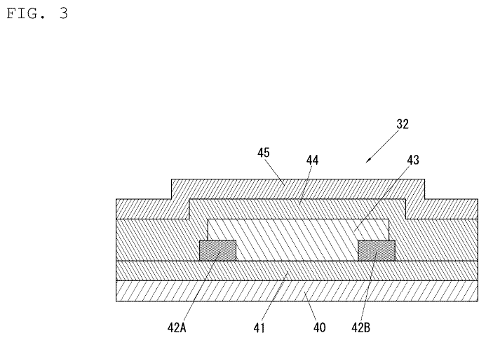

Furthermore, the heating unit 32 has a laminated structure as illustrated in FIG. 3 as a section taken along the line A-A′ in FIG. 2. Specifically, the heating unit 32 includes a board 40 extending annularly, for example, a wiring board 40 made of flexible printed circuits (FPC), a pair of annularly extending electrodes 42A and 42B disposed at predetermined positions on a radially inner side and a radially outer side on the board 40 via a copper foil adhesive layer 41, and a heating element 43 extending between the electrodes 42A and 42B and electrically connected to the electrodes 42A and 42B. In this case, in the present embodiment, a first electrode 42A is electrically connected to a positive electrode on the power supply side that is not illustrated, and a second electrode 42B is electrically connected to the negative electrode on the power supply side that is not illustrated (naturally, the first electrode 42A may be the negative electrode and the second electrode 42B may be the positive electrode), and both the electrodes 42A and 42B are formed by, for example, copper foil plating. Furthermore, the heating element 43 is formed of a resin, for example, polyethylene, epoxy resin, or the like, and a coverlay (for example, made of a PET (polyethylene terephthalate) material) 45 extending annularly with the coverlay adhesive layer 44 interposed therebetween is laminated on the copper foil adhesive layer 41 so as to cover the heating element 43 from the outside. In this case, a thickness of the board 40 is set to, for example, 0.05 mm, a thicknesses of the electrodes 42A and 42B are set to, for example, 0.038 mm, a thickness of the heating element 43 is set to, for example, 0.075 mm, and a thickness of the coverlay 45 is set to, for example, 0.075 mm.

Furthermore, the power supply unit 36 extends along the center line O′ of the annular body of the heating unit 32, and includes an FPC wiring board 40 extending from the heating unit 32, a pair of conductive first and second power supply lines 48A and 48B formed on the board 40, and the coverlay 45 (bonded via the coverlay adhesive layer 44) covering them. In this case, a first power supply line 48A is electrically connected to the first electrode 42A of the heating unit 32, and extends to the connector 34 so as to be electrically connected to the positive electrode on the power supply side (not illustrated). Furthermore, the second power supply line 48B is electrically connected to the second electrode 42B of the heating unit 32, and extends to the connector 34 so as to be electrically connected to the negative electrode on the power supply side (not illustrated). Furthermore, in the lens barrel 12, the power supply unit 36 is positioned in a guide groove 12a formed in an inner surface of the lens barrel 12, is guided along an optical axis O direction, is led out to the outside of the lens barrel 12 through a through hole 12b provided in the side surface of the lens barrel 12, and is electrically connected to the connector 34 positioned outside the lens barrel 12. Note that in a case where the lens barrel 12 has a polygonal inner surface, the power supply unit 36 may be guided in the lens barrel 12 along the optical axis O direction through a gap formed between a lens having a circular section and the inner surface of the lens barrel 12.

In the heater 30 having such a configuration, in a state where the connector 34 is electrically connected to, for example, the power supply side of the vehicle body, a voltage is applied between the electrodes 42A and 42B of the heating unit 32 through the power supply unit 36, and a current flows between the electrodes 42A and 42B through the heating element 43, whereby Joule heat is generated on the surface of the heating element 43, and the heat is transmitted to the lens 13 to heat the lens 13.

Next, with reference to FIG. 1 and FIG. 4 to FIG. 7, a method of incorporating the heater 30 in which the connector 34 is integrated into the lens barrel 12 (the lens unit 11) from the outside will be described.

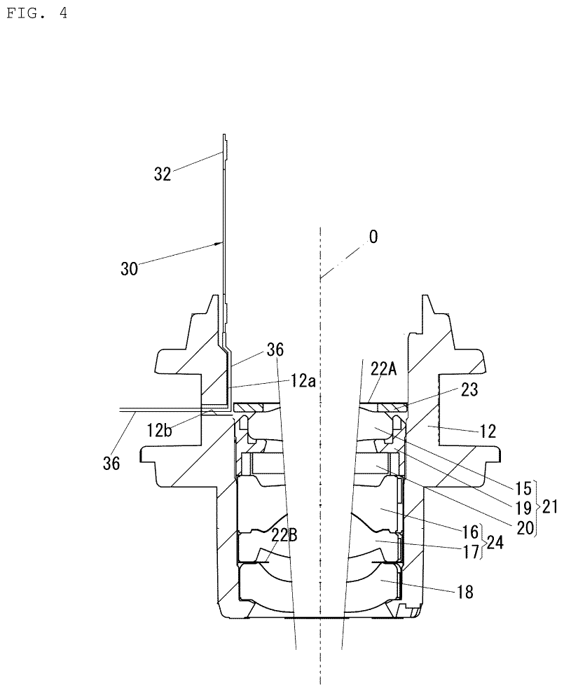

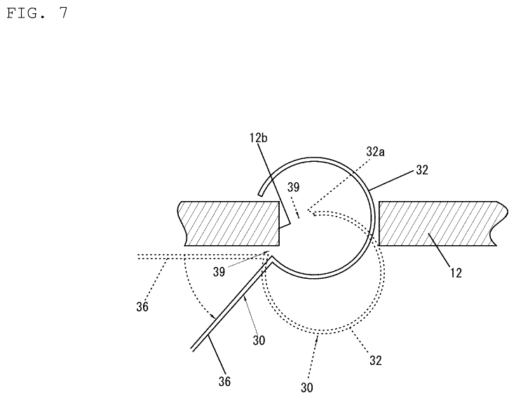

First, the sixth lens 18, the diaphragm member 22B, the fifth lens 17 and the fourth lens 16 constituting the bonded lens 24 are incorporated in the lens barrel 12 in this order from the object side. Then, in this incorporated state, as illustrated in FIG. 7, the annular heating unit 32 of the heater 30 is introduced into the lens barrel 12 along the annular shape (an arc) using the division portion 39 from the through hole 12b (see also FIG. 1) provided on the side surface of the lens barrel 12. Specifically, for example, in a state indicated by a broken line in FIG. 7, one end edge 32a of the annular body of the heating unit 32 formed by the division portion 39 is inserted into the through hole 12b, and while the heating unit 32 is rotated together with the power supply unit 36 as indicated by a broken line arrow, the heating unit 32 is gradually introduced into the lens barrel 12 along the annular shape (the arc) through the state indicated by the solid line while utilizing the elasticity of the heating unit 32 and the power supply unit 36, and the entire heating unit 32 is finally inserted into the lens barrel 12. Thereafter, a part of the power supply unit 36 is also drawn into the lens barrel 12 through the through hole 12b, the heating unit 32 is drawn toward the object side in the lens barrel 12 by bending the power supply unit 36 having elasticity, and the power supply unit 36 drawn into the lens barrel 12 is guided along the optical axis O direction while being positioned in the guide groove 12a formed in the inner surface of the lens barrel 12 to retract the heater 30 (the heating unit 32 and the power supply unit 36) from a lens incorporation path into the lens barrel 12. In the retracted state, the subassembly 21 including the third lens 15, the intermediate ring 23, and the diaphragm member 22 are incorporated in the lens barrel 12. This state is illustrated in FIG. 4.

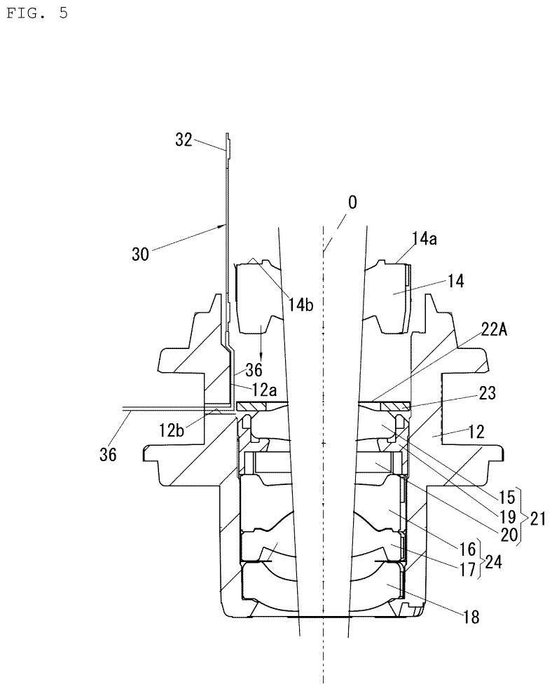

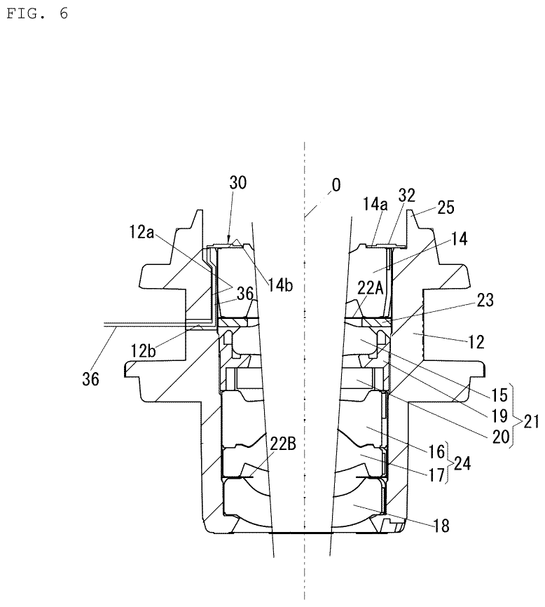

Next, from the state of FIG. 4 (in which the heating unit 32 and the power supply unit 36 are retracted from the lens incorporation path into the lens barrel 12), the second lens (image-side lens) 14 is incorporated into the lens barrel 12 as illustrated in FIG. 5, and then, as illustrated in FIG. 6, the heating unit 32 is placed on the object-side surface 14a of the second lens 14 that has been incorporated so as to be bent near a boundary with the power supply unit 36, and the heating unit 32 is positioned in the annular groove 14b formed on the outer periphery of the surface 14a of the second lens 14. Then, finally, the first lens (lens on the other object side) 13 to which the O-ring 27 is attached is placed on the second lens 14, the heating unit 32 is positioned between these lenses 13 and 14, and the caulking portion 23 is thermally caulked inward in the radial direction, thereby fixing the first lens 13 to the object side end portion of the lens barrel 12 (the state of FIG. 1).

Note that in a case where a through hole 12b′ as indicated by a broken line in FIG. 1 can be formed in the side surface of the lens barrel 12 at a position between the lenses 13 and 14, instead of the above-described incorporation method, an incorporation method can be adopted in which the heating unit 32 and the power supply unit 36 are linearly and horizontally inserted into the lens barrel 12 without being bent from the side through the through hole 12b′ and positioned on the second lens 14 in a state where the second lens 14 is incorporated in the lens barrel 12.

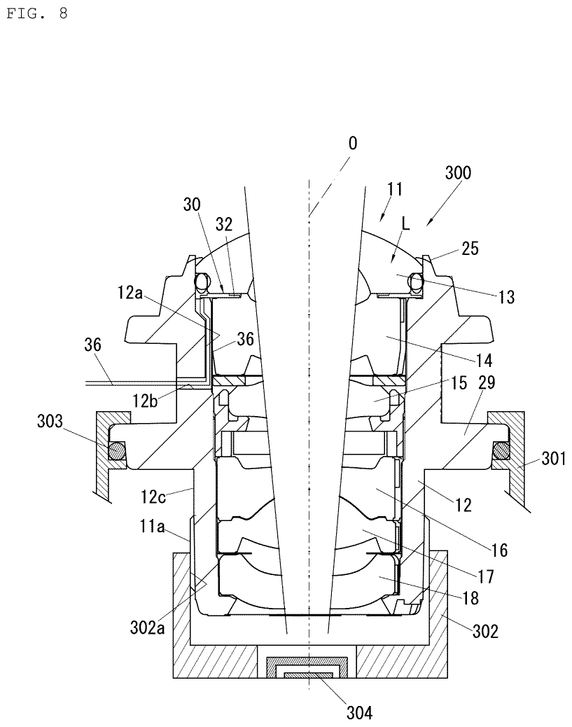

Furthermore, FIG. 8 is a schematic sectional view of a camera module 300 of the present embodiment including the lens unit 11 having the above configuration. As illustrated, the camera module 300 includes the lens unit 11 of FIG. 1 in which the heater 30 is incorporated.

The camera module 300 includes an upper case (a camera case) 301 that is an exterior component, and a mount (a base) 302 that holds the lens unit 11. Furthermore, the camera module 300 includes a seal member 303 and a package sensor (an image sensor) 304.

An upper case 301 is a member that is engaged with the flange portion 29 provided in a flange shape on an outer peripheral surface 12c of the lens barrel 12 and exposes the object side end portion of the lens unit 11 to cover the other portion. A mount 302 is disposed inside the upper case 301 and has a female screw 302a screwed with a male screw 11a of the lens unit 11. The seal member 303 is a member interposed between the inner surface of the upper case 301 and the outer peripheral surface 12c of the lens barrel 12 of the lens unit 11, and is a member for maintaining airtightness inside the upper case 301.

A package sensor 304 is disposed inside the mount 302 and is disposed at a position where an image of an object formed by the lens unit 11 is received. Furthermore, the package sensor 304 has a transparent cover on the outer side, and includes a CCD, a CMOS, or the like inside the transparent cover, and converts light collected and reaching through the lens unit 11 into an electric signal. The converted electric signal is converted into analog data or digital data that is a component of image data captured by the camera.

As described above, according to the present embodiment, since the heater 30 is an integrated heater in which the heating unit 32, the power supply unit 36, and the connector 34 are integrally formed, it is possible to prevent electrical connection failure and the like, and not only increase the electrical reliability but also reduce the number of components, which can contribute to the reduction in manufacturing cost. Furthermore, since a part of the annular body of the heating unit 32 is divided, the heating unit 32 can be easily introduced into the lens barrel 12 from the outside of the lens barrel 12 along the annular shape from the through hole 12b provided on the side surface of the lens barrel 12 using the division portion 39. This is particularly advantageous in a case where a size of the connector 34 increases (in particular, the size of the connector 34 exceeds the size of the lens unit 11) when the heater 30 is installed in the lens unit 11 mounted on a vehicle such as an automobile and receives power supply from the vehicle side as in the present embodiment. Furthermore, according to the present embodiment, in this way, since the integrated heater 30 can be incorporated from the outside into the lens barrel 12 as long as the through hole 12b is formed in the lens barrel 12, it is not necessary to divide the lens barrel 12 into two and incorporate the heater 30. Therefore, there is no need to increase the number of components of the lens unit 11, and it is possible to avoid a situation (deterioration in incorporation accuracy) in which a positional deviation or the like of the optical system or the heater occurs during connecting the two divided lens barrel portions. As a result, it is possible to obtain a sufficient snow melting and anti-fog function by the heater 30 while securing desired optical performance.

FIG. 9 illustrates an integrated heater 30A according to a second embodiment that can be incorporated in the lens unit 11 of FIG. 1. As illustrated in FIG. 9, the integrated heater 30A according to the present embodiment includes a pair of separate first and second heater units 35A and 35B formed integrally with corresponding connectors 34A and 34B electrically connected to the power supply side. In this case, the first heater unit 35A includes a first heating unit 32A that is disposed between the lenses 13 and 14 and generates heat by power supply, and a first power supply unit 36A that extends so as to electrically connect the corresponding connector 34A and the first heating unit 32A and supplies power to the first heating unit 32A, while the second heater unit 35B includes a second heating unit 32B that is disposed between the lenses 13 and 14 and generates heat by power supply, and a second power supply unit 36B that extends so as to electrically connect the corresponding connector 34B and the second heating unit 32B and supplies power to the second heating unit 32B, and in the first and second heating units 32A and 32B: in a state of being positioned in the annular groove 14b of the second lens 14 described above, one annular body is formed to face each other. In particular, in the present embodiment, each of heating units 32A and 32B has a semicircular shape.

Furthermore, similarly to the first embodiment described above, the first and second heating units 32A and 32B have a laminated structure as illustrated in FIG. 3 as a section taken along the line A-A′ in FIG. 9. In other words, each of the heating units 32A and 32B includes the board 40 extending in a semicircular shape, for example, the wiring board 40 made of flexible printed circuits (FPC), a pair of semicircularly extending electrodes 42A and 42B disposed at predetermined positions on a radially inner side and a radially outer side on the board 40 via the copper foil adhesive layer 41, and the heating element 43 extending between the electrodes 42A and 42B and electrically connected to the electrodes 42A and 42B. Also in this case, for example, the first electrode 42A is electrically connected to the positive electrode on the power supply side (not illustrated), the second electrode 42B is electrically connected to the negative electrode on the power supply side (not illustrated), and both the electrodes 42A and 42B are formed by, for example, the copper foil plating. Furthermore, the semicircularly extending coverlay 45 with the coverlay adhesive layer 44 interposed therebetween so as to cover the heating element 43 from the outside is laminated on the copper foil adhesive layer 41.

Furthermore, the first and second power supply units 36A and 36B respectively extend from one ends of the corresponding first and second heating units 32A and 32B along a center line O′ of an annular body formed by the heating units 32A and 32B in cooperation, and include the FPC wiring board 40 extending from the corresponding heating units 32A and 32B, a pair of conductive first and second power supply lines 48A and 48B formed on the board 40, and the coverlay 45 (bonded via the coverlay adhesive layer 44) covering these. In this case, the first power supply line 48A is electrically connected to the first electrode 42A of the corresponding heating units 32A and 32B, and extends to the corresponding connectors 34A and 34B so as to be electrically connected to the positive electrode on the power supply side (not illustrated). Furthermore, the second power supply line 48B is electrically connected to the second electrode 42B of the corresponding heating units 32A and 32B, and extends to the corresponding connectors 34A and 34B so as to be electrically connected to the negative electrode on the power supply side (not illustrated). Furthermore, in the lens barrel 12, the power supply units 36A and 36B are positioned in the guide groove 12a formed in an inner surface of the lens barrel 12 and guided along the optical axis O direction, are led out to the outside of the lens barrel 12 through a through hole 12b provided in the side surface of the lens barrel 12, and are electrically connected to the corresponding connectors 34A and 34B located outside the lens barrel 12.

Note that in the present embodiment, the first and second power supply units 36A and 36B are formed integrally with the corresponding separate connectors 34A and 34B, respectively, but the first and second power supply units 36A and 36B may be formed integrally with one common connector 34 as indicated by the broken line in FIG. 9.

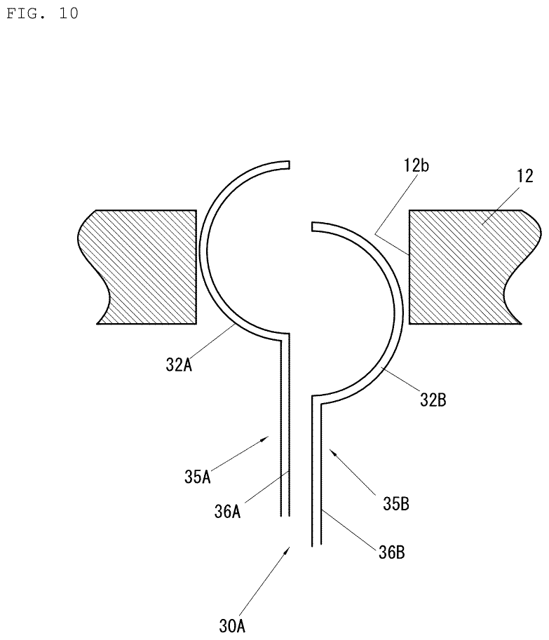

In a case where the heater 30A having such a configuration is incorporated into the lens barrel 12 (the lens unit 11) from the outside, as in the first embodiment described above, to start with, the sixth lens 18, the diaphragm member 22B, the fifth lens 17 and the fourth lens 16 constituting the bonded lens 24 are incorporated into the lens barrel 12 in this order from the object side. Then, in this incorporated state, as illustrated in FIG. 10, the first and second heating units 32A and 32B of the first and second heater units 35A and 35B are individually introduced into the lens barrel 12 from the through hole 12b provided on the side surface of the lens barrel 12. Thereafter, parts of the first and second power supply units 36A and 36B are also drawn into the lens barrel 12 through the through hole 12b, and brought into a state similar to the state of FIG. 4 described above in which the two heater units 35A and 35B are drawn into the lens barrel 12 in a parallel state. Thereafter, after the second lens (the image-side lens) 14 is incorporated into the lens barrel 12 as illustrated in FIG. 5, the first and second heating units 32A and 32B are placed on the object-side surface 14a of the second lens 14 that has been incorporated so as to be bent near a boundary with the power supply unit 36, and the heating units 32A and 32B are positioned in a facing state so as to form the annular body in an annular groove 14b formed on the outer periphery of the surface 14a of the second lens 14. Then, finally, the first lens (lens on the other object side) 13 to which the O-ring 27 is attached is placed on the second lens 14, the heating units 32A and 32B are positioned between these lenses 13 and 14, and the caulking portion 23 is thermally caulked inward in the radial direction, thereby fixing the first lens 13 to the object side end portion of the lens barrel 12 (the state of FIG. 1).

As described above, according to the present embodiment, the same functions and effects as those of the first embodiment described above can be obtained, and the first heating unit 32A and the second heating unit 32B cooperate to form a completely closed annular body that is not divided, so that the sufficient amount of heat generation can be secured and the heating distribution (the temperature distribution) can be uniform over the entire lens.

FIG. 11 illustrates an integrated heater 30B according to a third embodiment that can be incorporated in the lens unit 11 of FIG. 1. As illustrated in FIG. 11, the integrated heater 30B according to the present embodiment includes the heating unit 32 as an annular body that is disposed between the lenses 13 and 14 and generates heat by power supply, the connector 34 electrically connected to the power supply side, and the power supply unit 36 that extends along the center line O′ of the annular body so as to electrically connect the connector 34 and the heating unit 32 and supplies power to the heating unit 32, in which the heating unit 32, the power supply unit 36, and the connector 34 are integrally formed.

Furthermore, in the integrated heater 30B of the present embodiment, separation regions 50A and 50B are formed along the center line O′ of the annular body of the heating unit 32, so that the heating unit 32 and the power supply unit 36 can be bent along the center line O′. Specifically, the heating unit 32 is separated into a first heating region 32A′ and a second heating region 32B′ by a pair of separation regions 50A formed in the heating unit 32 radially opposite along the center line O′, and a power supply unit 36 is separated into a first power supply region 36A′ and a second power supply region 36B′ by a separation region 50B formed in the power supply unit 36 so as to linearly extend along the center line O′.

Each of the first and second heating regions 32A′ and 32B′ has a laminated structure as illustrated in FIG. 3 as a section taken along the line A-A′ in FIG. 11, similarly to the first embodiment described above. In other words, each of the heating regions 32A′ and 32B′ individually has the board 40 common to two regions extending annularly and continuously as a whole across the two heating regions 32A′ and 32B′, for example, the wiring board 40 made of flexible printed circuits (FPC), a pair of semicircularly extending electrodes 42A and 42B disposed at predetermined positions on a radially inner side and a radially outer side on the board 40 via the copper foil adhesive layer 41, and the heating element 43 extending between the electrodes 42A and 42B and electrically connected to the electrodes 42A and 42B. Also in this case, the first electrode 42A of each of the heating regions 32A′ and 32B′ is electrically connected to the positive electrode on the power supply side (not illustrated), and the second electrode 42B of each of the heating regions 32A′ and 32B′ is electrically connected to the negative electrode on the power supply side (not illustrated), and both the electrodes 42A and 42B are formed by, for example, copper foil plating. Furthermore, the coverlay 45 is laminated on the copper foil adhesive layer 41 with the coverlay adhesive layer 44 interposed therebetween so as to cover the heating element 43 from the outside. This coverlay 45 extends continuously, generally annularly, across the first heating region 32A′ and the second heating region 32B′.

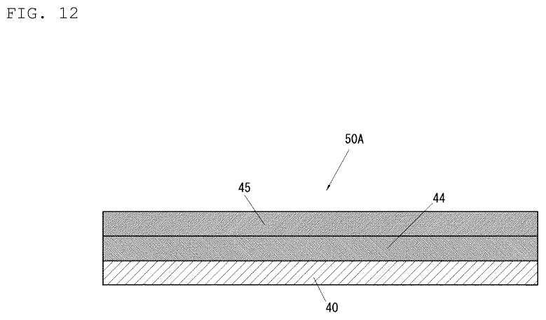

Furthermore, in the separation region 50A that separates the heating unit 32 into the first heating region 32A′ and the second heating region 32B′, the electrodes 42A, 42B and the heating element 43 and the copper foil adhesive layer 41 are separated between the first heating region 32A′ and the second heating region 32B′, thereby providing only the substrate 41 and the coverlay adhesive layer 44 and the coverlay 45 as shown in FIG. 12 (a sectional view taken along the line B-B′ of FIG. 11 in the separation region 50A), thereby providing increased flexibility and being bendable along the center line O′ of the annular body of the heating unit 32.

Furthermore, the first and second power supply regions 36A′, 36B′ each extend from one end of the corresponding first and second heating regions 32A′, 32B′ along the center line O′ of the annular body of the heating unit 32, and individually have a pair of conductive first and second power supply lines 48A and 48B on the FPC wiring board 40 extending from the heating unit 32 and common to the two regions. In this case, the power supply lines 48A and 48B are covered by the coverlay 45 via the coverlay adhesive layer 44, and the coverlay 45 extends continuously across the two power supply regions 36A′ and 36B′.

The first power supply line 48A of each power supply region 36A′ and 36B′ is electrically connected to the first electrode 42A of the corresponding heating region 32A′ and 32B′ and extends to the connector 34 so as to be electrically connected to the positive electrode on the power supply side (not illustrated). Furthermore, the second power supply line 48B of each power supply region 36A′ and 36B′ is electrically connected to the second electrode 42B of the corresponding heating region 32A′ and 32B′, and extends to the connector 34 so as to be electrically connected to the negative electrode on the power supply side (not illustrated).

The separation region 50B separating the power supply unit 36 into the first power supply region 36A′ and the second power supply region 36B′ is only the substrate 41 and the coverlay adhesive layer 44 and the coverlay 45 similarly to the separation region 50A of the heating unit 32 by separating the power supply lines 48A and 48B of the first power supply region 36A′ and the power supply lines 48A and 48B of the second power supply region 36B′ to the left and right with the center line O′ of the annular body of the heating unit 32 as a boundary, thereby increasing flexibility and being bendable along the center line O′ of the annular body of the heating unit 32.

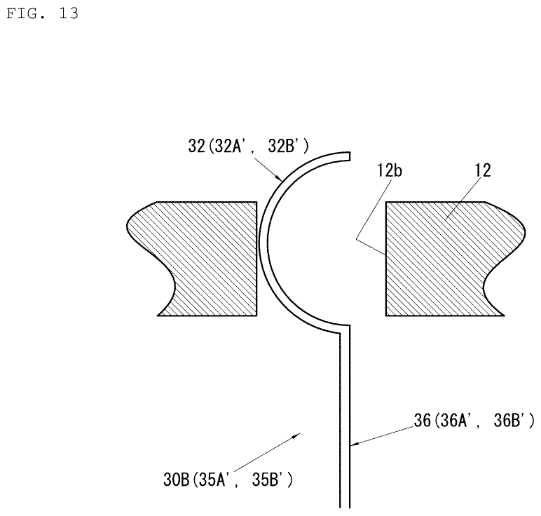

In a case where the heater 30B having such a configuration is incorporated into the lens barrel 12 (the lens unit 11) from the outside, as in the first embodiment described above, to start with, the sixth lens 18, the diaphragm member 22B, the fifth lens 17 and the fourth lens 16 constituting the bonded lens 24 are incorporated into the lens barrel 12 in this order from the object side. Then, in this incorporated state, as illustrated in FIG. 13, in a state where the heating unit 32 and the power supply unit 36 are bent along the center line O′ of the annular body, the heating unit 32 is introduced into the lens barrel 12 through the through hole 12b provided in the side surface of the lens barrel 12. Thereafter, a part of the power supply unit 36 is also drawn into the lens barrel 12 through the through hole 12b. The heating unit 32 and the power supply unit 36 are developed to an original state (a developed state illustrated in FIG. 11) to reach the state of FIG. 4 described above. Thereafter, the second lens (the image-side lens) 14 is incorporated into the lens barrel 12 as illustrated in FIG. 5, and then the heating unit 32 is placed on the object-side surface 14a of the second lens 14 that has been incorporated so as to be bent near the boundary with the power supply unit 36, and is positioned in the annular groove 14b formed on the outer periphery of the surface 14a of the second lens 14. Then, finally, the first lens (lens on the other object side) 13 to which the O-ring 27 is attached is placed on the second lens 14, the heating unit 32 is positioned between these lenses 13 and 14, and the caulking portion 23 is thermally caulked inward in the radial direction, thereby fixing the first lens 13 to the object side end portion of the lens barrel 12 (the state of FIG. 1).

As described above, according to the present embodiment, the same functions and effects as those of the first embodiment described above can be obtained, and the heating units 32 form a completely closed annular body that is not divided, so that a sufficient amount of heat generation can be secured and the heating distribution (the temperature distribution) can be uniform over the entire lens.

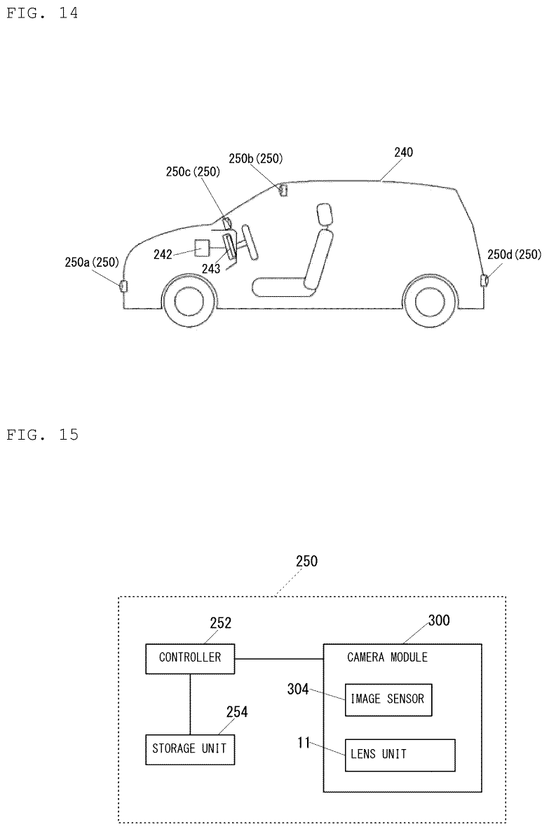

FIG. 14 schematically illustrates a vehicle 240 as a mobile body on which an in-vehicle system (an imaging system) having an imaging apparatus 250 including the camera module 300 of FIG. 8 is mounted. As illustrated, the imaging apparatus 250 can be mounted on the vehicle 240, and FIG. 14 is an arrangement example illustrating a mounting position of the imaging apparatus 250 in the vehicle 240. The imaging apparatus 250 mounted on the vehicle 240 can also be referred to as an in-vehicle camera, and can be installed at various places of the vehicle 240. For example, a first imaging apparatus 250a may be disposed at or near a front bumper as a camera for monitoring the front when the vehicle 240 travels. Furthermore, a second imaging apparatus 250b that monitors the front may be disposed near an inner rearview mirror in a cabin of the vehicle 240. A third imaging apparatus 250c may be disposed on a dashboard, in an instrument panel, or the like as a camera for monitoring driving situations of the driver. A fourth imaging apparatus 250d may be installed at a rear portion of the vehicle 240 for a rear monitor of the vehicle 240. The imaging apparatuses 250a and 250b can be referred to as front cameras. The third imaging apparatus 250c can be referred to as an in-camera. The fourth imaging apparatus 250d can be referred to as a rear camera. The imaging apparatus 250 is not limited thereto, and includes imaging apparatuses installed at various positions such as a left side camera that images a left rear side and a right side camera that images a right rear side.

An image signal of an image captured by the imaging apparatus 250 can be output to an information processing apparatus (a controller) 242 and/or a display apparatus (an output apparatus) 243 in the vehicle 240. The information processing apparatus 242 and the display apparatus 243 constitute an in-vehicle system together with the imaging apparatus 250. The information processing apparatus 242 in the vehicle 240 includes an apparatus that processes an image signal (a captured image) acquired by the imaging apparatus 250, recognizes the image (recognizes an object in the captured image), and supports driving of the driver. Furthermore, the information processing apparatus 242 is configured to output the recognition information of the object in the captured image to the display apparatus 243, and includes, for example, a navigation apparatus, a collision damage reduction brake apparatus, an inter-vehicle distance control apparatus, a lane deviation warning apparatus, and the like, but is not limited thereto. The display apparatus 243 displays an image processed and output by the information processing apparatus 242, but can also directly receive an image signal from the imaging apparatus 250. Furthermore, the display apparatus 243 may employ a liquid crystal display (LCD), an organic electro-luminescence (EL) display, and an inorganic EL display, but is not limited thereto. The display apparatus 243 can display, to the driver, an image signal output from the imaging apparatus 250 that captures an image of a position difficult to be visually recognized by the driver, such as the rear camera (can output information to an occupant).

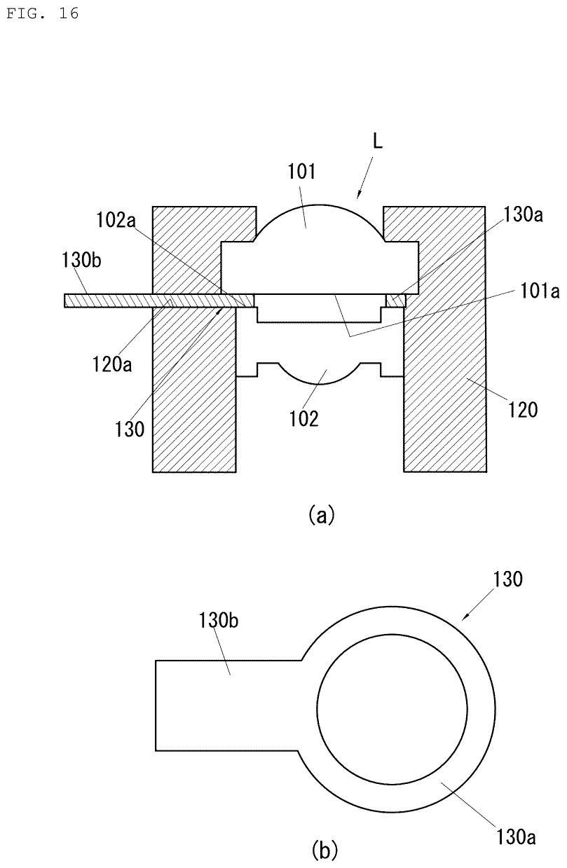

FIG. 15 illustrates a configuration of the imaging apparatus included in the in-vehicle system of FIG. 14. As illustrated, the imaging apparatus 250 according to the embodiment includes a controller 252, a storage unit 254, and the camera module 300 in FIG. 8 described above.

The controller 252 controls the camera module 300 and processes the electric signal output from an image sensor 304 of a camera module 80. The controller 252 may be configured as, for example, a processor. Furthermore, the controller 252 may include one or more processors. The processor may include a general-purpose processor that loads a specific program and executes a specific function, and a dedicated processor specialized for specific processing. The dedicated processor may include an application-specific integrated circuit (IC). The application-specific IC is also referred to as an application specific integrated circuit (ASIC). The processors may include a programmable logic apparatus. The programmable logic device is also referred to as a PLD. The PLD may include a field-programmable gate array (FPGA). The controller 252 may be either a system-on-a-chip (SoC) in which one or more processors cooperate or a system in a package (SiP). Furthermore, the controller 252 may have a function similar to that of the information processing apparatus 242 described above, and for example, may process a captured image output from the image sensor 304 and recognize an object in the captured image.

The storage unit 254 stores various types of information or parameters related to the operation of the imaging apparatus 250. The storage unit 254 may include, for example, a semiconductor memory or the like. The storage unit 254 may function as a work memory of the controller 252. The storage unit 254 may store the captured image. The storage unit 254 may store various parameters and the like for the controller 252 to perform detection processing based on the captured image. The storage unit 254 may be included in the controller 252.

As described above, the camera module 300 captures a subject image formed via the lens unit 11 by the image sensor 304, and outputs the captured image. The image captured by the camera module 300 is also referred to as a captured image.

The image sensor 304 may include, for example, a complementary metal oxide semiconductor (CMOS) image sensor, a charge coupled device (CCD), or the like. The image sensor 304 has an imaging surface on which a plurality of pixels is arranged. Each pixel outputs a signal specified by a current or a voltage according to the amount of incident light. A signal output from each pixel is also referred to as imaging data.

The imaging data may be read out by the camera module 300 for all the pixels and taken into the controller 252 as a captured image. The captured image read for all the pixels is also referred to as a maximum captured image. The imaging data may be read by the camera module 300 for some pixels and captured as the captured image. In other words, the imaging data may be read from pixels in a predetermined capturing range. The captured image data read from the pixels in the predetermined capturing range may be captured as the captured image. The predetermined capturing range may be set by the controller 252. The camera module 300 may acquire a predetermined capturing range from the controller 252. The image sensor 304 may capture an image in a predetermined capturing range of the subject image formed via the lens unit 11.

Although the present invention has been described in connection with various embodiments, the present invention is not limited to the embodiments described above, and various modifications can be made without departing from the gist thereof. For example, in the present invention, the shape of the lens, the lens barrel, and the like is not limited to the shape of the embodiment described above. Furthermore, an installation location and the number of heaters are not limited. Furthermore, the positions and the number of through holes provided in the lens barrel for inserting the heater are not limited. Furthermore, a part or all of the embodiments described above may be combined, or a part of the configuration may be omitted from one of the embodiments described above without departing from the gist of the present invention.

### REFERENCE SIGNS LIST

11 lens unit
12 lens barrel
13 first lens (object-side lens)
14 second lens (image-side lens)
30 heater
32 heating unit
32A first heating unit
32B second heating unit
34 connector
35A first heater unit
35B second heater unit
36 power supply unit
36A first power supply unit
36B second power supply unit
39 division portion
42A, 42B electrodes
43 heating element
300 camera module
240 vehicle (mobile body)
L lens group
O optical axis

1. A heater that is installed in a lens unit formed by housing a plurality of lenses in a lens barrel and transmits heat generated by power supply to the lenses, the heater comprising:
a heating unit as an annular body disposed between the lenses and configured to generate heat by power supply;
a connector electrically connected to a power supply side; and
a power supply unit that extends so as to electrically connect the connector and the heating unit and supplies power to the heating unit; wherein
the heating unit, the power supply unit, and the connector are integrally formed, and a part of an annular body of the heating unit is divided.

2. A heater that is installed in a lens unit formed by housing a plurality of lenses in a lens barrel and transmits heat generated by power supply to the lenses, the heater comprising:
a pair of first and second heater units formed integrally with a connector electrically connected to a power supply side, wherein
the first heater unit includes a first heating unit that is disposed between the lenses and generates heat by power supply, and a first power supply unit that extends to electrically connect the connector and the first heating unit and supplies power to the first heating unit, and
the second heater unit includes a second heating unit that is disposed between the lenses and generates heat by power supply, and a second power supply unit that extends to electrically connect the connector and the second heating unit and supplies power to the second heating unit, and
the first and second heating units face each other to form one annular body.

3. A heater that is installed in a lens unit formed by housing a plurality of lenses in a lens barrel and transmits heat generated by power supply to the lenses, the heater comprising:
a heating unit as an annular body disposed between the lenses and configured to generate heat by power supply;
a connector electrically connected to a power supply side; and
a power supply unit that extends along a center line of the annular body so as to electrically connect the connector and the heating unit and supplies power to the heating unit; wherein
the heating unit, the power supply unit, and the connector are integrally formed, and the heating unit and the power supply unit are bendable along a center line of the annular body.

4. The heater according to claim 3, wherein
the heating unit includes a heating element and at least a pair of electrodes electrically connected to the heating element, and when a voltage is applied between the electrodes, a current flows through the heating element to generate Joule heat on a surface of the heating element, and
the heating unit and the power supply unit are bendable by separating the electrodes and the heating element along a center line of the annular body.

5. A lens unit comprising: a lens group formed by arranging a plurality of lenses along an optical axis of the lens; a lens barrel in which the lens group is housed; and a heater that transfers heat generated by power supply to the lens, wherein
the heater is the heater according to any one of claims 1 to 4, and the lens barrel has a through hole for introducing the heating unit of the heater into the lens barrel.

6. A camera module comprising: the lens unit according to claim 5; and an image sensor that converts light condensed through the lens group of the lens unit into an electric signal.

7. An in-vehicle system mounted on a vehicle, comprising:
the camera module according to claim 6; and
a controller that processes a captured image output from the image sensor of the camera module and recognizes an object in the captured image.

8. A mobile body mounted with the in-vehicle system according to claim 7 and an output apparatus that outputs information to an occupant, wherein
the controller is configured to output recognition information of the object to the output apparatus.

9. A method of incorporating a heater formed by integrally forming a connector with a lens unit formed by accommodating a lens group in a lens barrel, the lens group including a plurality of lenses arranged along an optical axis of the lenses, the method comprising:
a step of preparing a heater formed by integrally forming a heating unit as an annular body that generates heat by power supply, a connector electrically connected to a power supply side, and a power supply unit that extends so as to electrically connect the connector and the heating unit and supplies power to the heating unit, the heater including a division portion that divides a part of the annular body of the heating unit;
a step of introducing the heating unit into the lens barrel along an annular shape of the heating unit from a through hole provided in a side surface of the lens barrel by using the division portion;
a step of positioning and arranging the heating unit on an image-side lens constituting the lens group by drawing the heating unit into the lens barrel such that the power supply unit is inserted into the through hole; and
a step of placing a lens on another object side on the lens on the image side and positioning the heating unit between these lenses.

10. A method of incorporating a heater formed by integrally forming a connector with a lens unit formed by housing a lens group in a lens barrel, the lens group including a plurality of lenses arranged along an optical axis of the lenses, the method comprising:
a step of preparing a heater including a pair of first and second heater units formed integrally with a connector electrically connected to a power supply side, wherein the first heater unit includes a first heating unit disposed between the lenses and configured to generate heat by power supply, and a first power supply unit extending to electrically connect the connector and the first heating unit and configured to supply power to the first heating unit; the second heater unit includes a second heating unit disposed between the lenses and configured to generate heat by power supply, and a second power supply unit extending to electrically connect the connector and the second heating unit and configured to supply power to the second heating unit; and the first and second heating units face each other and form one annular body;
a step of individually introducing the first and second heating units into the lens barrel from through holes provided in a side surface of the lens barrel;
a step of positioning and arranging the first and second heating units in a facing state so as to form the annular body on the lens on the image side constituting the lens group by drawing the first and second heating units into the lens barrel such that the first and second power supply units are inserted into the through holes; and
a step of placing a lens on the other object side on the lens on the image side and positioning the first and second heating units between these lenses.

11. A method of incorporating a heater formed by integrally forming a connector with a lens unit formed by housing a lens group in a lens barrel, the lens group including a plurality of lenses arranged along an optical axis of the lenses, the method comprising:
a step of preparing a heater integrally forming a heating unit as an annular body that generates heat by power supply, a connector electrically connected to a power supply side, and a power supply unit that extends along a center line of the annular body so as to electrically connect the connector and the heating unit and supplies power to the heating unit, wherein the heating unit and the power supply unit are bendable along the center line of the annular body;
a step of introducing the heating unit into the lens barrel through a through hole provided in a side surface of the lens barrel in a state where the heating unit and the power supply unit are bent along a center line of the annular body;
a step of developing the heating unit and the power supply unit to an original state while drawing the heating unit into the lens barrel such that the power supply unit is inserted into the through hole, and positioning and arranging the heating unit on an image-side lens constituting the lens group; and
a step of placing a lens on another object side on the lens on the image side and positioning the heating unit between these lenses.
